(19) United States
(12) Patent Application Publication
(10) Pub. No.: US 2019/0108060 A1
(43) Pub. Date: Apr. 11, 2019

(54) MOBILE RESOURCE SCHEDULER

(71) Applicant: NOKIA SOLUTIONS AND NETWORKS OY, ESPOO (FI)

(72) Inventors: Abdelkader Outtagarts, Antony (FR); Duc Hung Luong, Antony (FR); Huu Trung Thieu, Bagneux (FR)

(21) Appl. No.: 15/727,942

(22) Filed: Oct. 9, 2017

(51) Int. Cl. G06F 9/50; G06F 9/48; G06F 9/455

(52) U.S. Cl. CPC G06F 9/5005; G06F 9/45558; G06F 9/4881; G06F 9/5077

(57) ABSTRACT

The present disclosure generally discloses a resource scheduling capability that is configured to support scheduling of resources in a virtualization environment. The resource scheduling capability, in a virtualization environment including a set of physical resources configured to provide a set of virtual resources, is configured to support scheduling of the physical resources for use in providing the virtual resources. The resource scheduling capability is based on use of a mobile resource scheduler that is configured to roam within the virtualization environment to obtain information for use in scheduling physical resources to provide virtual resources.

### TECHNICAL FIELD

The present disclosure relates generally to resource management and, more particularly but not exclusively, to resource scheduling.

### BACKGROUND

Virtualization environments typically include various physical resources (e.g., processing resources, memory resources, storage resources, and so forth) which may be allocated for use in providing various virtual resources (e.g., virtual machines, virtual containers, and so forth). Such virtualization environments typically include resource management systems configured to manage the physical resources and the virtual resources. Such resource management systems typically include resource scheduling capabilities for scheduling the use of the physical resources to provide the virtual resources.

### SUMMARY

The present disclosure generally discloses resource scheduling capabilities configured to use a mobile resource scheduler.

In at least some embodiments, an apparatus is provided. The apparatus is configured to support resource scheduling functions based on a mobile resource scheduler. The apparatus includes a processor and a memory communicatively connected to the processor. The processor is configured to receive, by a node of a virtualization environment where the node includes a set of physical resources configured to support a set of virtual resources, a mobile resource scheduler. The processor is configured to determine, by the mobile resource scheduler based on predicted resource availability information indicative of availability of resources of the node, resource scheduling control information. The processor is configured to send, by the node toward an intended destination, the mobile resource scheduler. In at least some embodiments, a non-transitory computer-readable storage medium stores instructions which, when executed by a computer, cause the computer to perform a corresponding method for supporting resource scheduling functions based on a mobile resource scheduler. In at least some embodiments, a corresponding method for supporting resource scheduling functions based on a mobile resource scheduler is provided.

In at least some embodiments, an apparatus is provided. The apparatus is configured to support resource scheduling functions based on a mobile resource scheduler. The apparatus includes a processor and a memory communicatively connected to the processor. The processor is configured to send, by a resource controller of a virtualization environment toward a first node of the virtualization environment, a mobile resource scheduler. The processor is configured to receive, by the resource controller from a second node of the virtualization environment, the mobile resource scheduler. The mobile resource scheduler is configured to determine, based on predicted resource availability information of one or more nodes of the virtualization environment, resource scheduling control information. In at least some embodiments, a non-transitory computer-readable storage medium stores instructions which, when executed by a computer, cause the computer to perform a corresponding method for supporting resource scheduling functions based on a mobile resource scheduler. In at least some embodiments, a corresponding method for supporting resource scheduling functions based on a mobile resource scheduler is provided.

In at least some embodiments, an apparatus is provided. The apparatus is configured to support resource scheduling functions based on a mobile resource scheduler. The apparatus includes a processor and a memory communicatively connected to the processor. The processor is configured to determine, by a mobile resource scheduler running on a first node of a virtualization environment from a local resource scheduler running on the first node, predicted resource availability information indicative of availability of physical resources of the first node. The processor is configured to determine, by the mobile resource scheduler running on the first node based on the predicted resource availability information, resource scheduling control information for a set of nodes of the virtualization environment, the set of nodes including the first node and at least a second node of the virtualization environment. In at least some embodiments, a non-transitory computer-readable storage medium stores instructions which, when executed by a computer, cause the computer to perform a corresponding method for supporting resource scheduling functions based on a mobile resource scheduler. In at least some embodiments, a corresponding method for supporting resource scheduling functions based on a mobile resource scheduler is provided.

### BRIEF DESCRIPTION OF THE DRAWINGS

The teachings herein can be readily understood by considering the following detailed description in conjunction with the accompanying drawings, in which:

FIG. 1 depicts a virtualization environment configured to support use of physical resources to provide virtual resources and including a mobile resource scheduler;

FIG. 2 depicts an embodiment of a method for use by a node of a virtualization environment to support use of a mobile resource scheduler for supporting resource scheduling functions within the virtualization environment;

FIG. 3 depicts an embodiment of a method for use by a resource controller of a virtualization environment to support use of a mobile resource scheduler for supporting resource scheduling functions within the virtualization environment;

FIG. 4 depicts an embodiment of a method for use by a mobile resource scheduler for supporting resource control functions within the virtualization environment; and

FIG. 5 depicts a high-level block diagram of a computer suitable for use in performing various functions presented herein.

To facilitate understanding, identical reference numerals have been used, where possible, to designate identical elements that are common to the figures.

### DETAILED DESCRIPTION

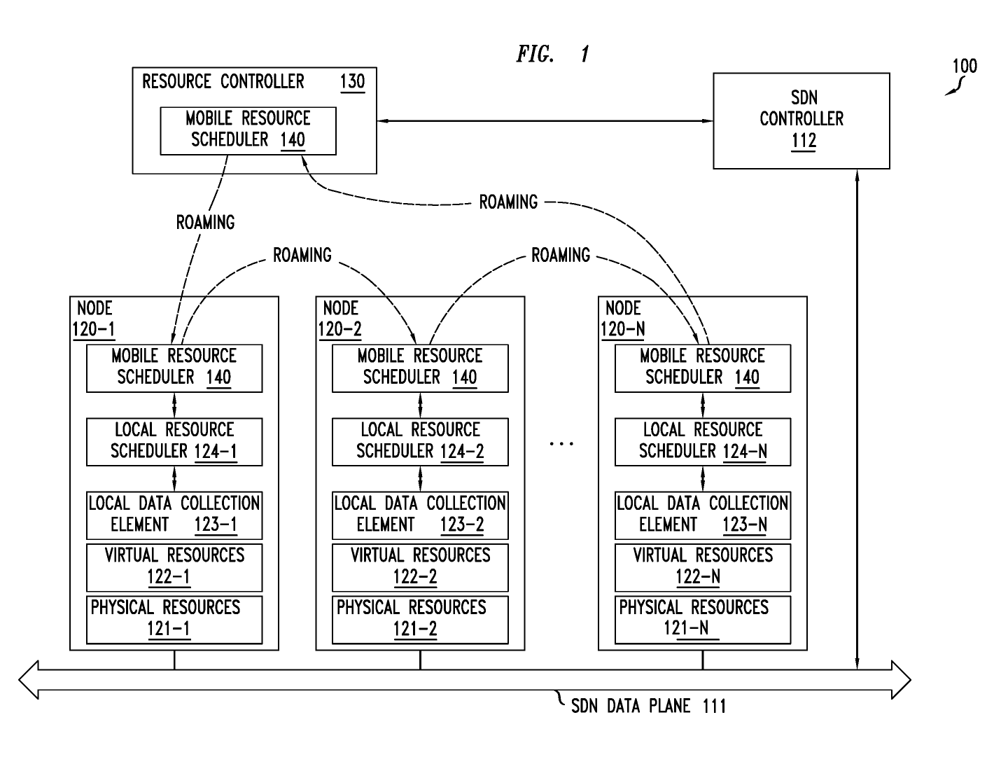

The present disclosure generally discloses a resource scheduling capability. The resource scheduling capability is configured to support scheduling of resources in a virtualization environment. The resource scheduling capability, in a virtualization environment including a set of physical resources configured to provide a set of virtual resources, is configured to support scheduling of the physical resources for use in providing the virtual resources. The resource scheduling capability is based on use of a mobile resource scheduler. The mobile resource scheduler is configured to be mobile within the virtualization environment, roaming within the virtualization environment to obtain information for use in performing scheduling of the physical resources for use in providing the virtual resources. The mobile resource scheduler, in a virtualization environment including a resource controller and a set of nodes including respective sets of physical resources configured to provide virtual resources, may be configured to roam from the resource controller to nodes, roam between nodes, roam from nodes to the resource controller, or the like, as well as various combinations thereof. The mobile resource scheduler is configured to provide improved resource scheduling within the virtualization environment (as compared with use of a centralized resource scheduler), thereby providing improved scheduling of the physical resources of the virtualization environment for use in providing the virtual resources of the virtualization environment. The resource scheduling capability is configured to utilize a roaming mobile resource scheduler (e.g., which roams the nodes of the virtualization environment to collect results from the nodes locally and dynamically rank the nodes of the virtualization environment based on the collected results), rather than a central resource scheduler (e.g., which collects results from the nodes remotely and creates a more static ranking of the nodes of the virtualization environment), thereby enabling the image of available resources of the virtualization environment to be closer to reality. It will be appreciated that these and various other embodiments and advantages or potential advantages of the resource scheduling capability may be further understood by way of reference to the example virtualization environment of FIG. 1.

FIG. 1 depicts a virtualization environment configured to support use of physical resources to provide virtual resources and including a mobile resource scheduler.

The virtualization environment 100 is configured to support virtualization of physical resource to provide virtual resources. The virtualization environment 100 may be a portion of a datacenter, a datacenter, multiple datacenters, or the like. The virtualization environment 100 may support resource virtualization within various contexts, such as for application virtualization, service virtualization, network function virtualization (e.g., virtualization of an Evolved Packet Core (EPC) of a Fourth Generation (4G) Long Term Evolution (LTE) cellular wireless network, virtualization of a core network portion of a Fifth Generation (5G) cellular wireless network, or the like), virtualization of an Internet-of-Things (IoT) environment to provide IoT slices, or the like, as well as various combinations thereof.

The virtualization environment 100 includes a software defined networking (SDN)-based network (including an SDN data plane 111 and an SDN controller 112 controlling the SDN data plane 111) supporting communications of a set of nodes 120-1-120-N (collectively, nodes 120) managed by a resource controller (RC) 130. The virtualization environment 100 also includes a mobile resource scheduler (MRS) 140 that is configured to roam between elements of the virtualization environment 100 (illustratively, roaming from the RC 130 to nodes 120, roaming between nodes 120, roaming from nodes 120 to the RC 130, or the like, as well as various combinations thereof).

The SDN-based network provided by SDN data plane 111 and SDN controller 112 is configured to support communications of the virtualization environment 100.

The SDN data plane 111 of SDN-based network is configured to support communications of nodes 120, which may include communications between the nodes 120 within the virtualization environment 100, communication between the nodes 120 of the virtualization environment 100 and elements located outside of the virtualization environment 100 (e.g., end user devices or network devices accessing an application where the virtualization environment 100 provides application virtualization, end user devices or network devices accessing a service where the virtualization environment 100 provides service virtualization, wireless access devices where the virtualization environment 100 provides network function virtualization, or the like), or the like, as well as various communications thereof. It will be appreciated that, although omitted for purposes of clarity, SDN data plane 111 may include various network elements configured to support communications within the virtualization environment 100 (e.g., switches (e.g., physical switches (e.g., top-of-rack (ToR) switches, end-of-rack (EoR) switches, aggregating switches, or the like), virtual switches, or the like), routers, or the like, as well as various combinations thereof).

The SDN controller 112 of SDN-based network is configured to control the SDN data plane 111 of SDN-based network. The SDN controller 112 is configured to programmatically control network behavior of the SDN data plane 111 dynamically. The SDN controller 112 is configured to manage flow control within the SDN data plane 111 (e.g., determining routes for new flows, installing flow entries on elements of the SDN data plane 111 for flow handling within the SDN data plane 111, and so forth). The typical operation of an SDN controller such as SDN controller 112 in controlling an SDN data plane such as SDN data plane 111 will be understood by one skilled in the art. The SDN controller 112, as discussed further below, also may be configured to interface with the RC 130 for purposes of providing network status information to the RC 130, where such network status information may be used by RC 130 in performing resource control functions for the nodes 120 and may be used by the MRS 140 when visiting the RC 130 for purposes of providing resource scheduling functions for the nodes 120.

It will be appreciated that, although primarily presented herein with respect to use of an SDN-based communication network to support the communications of the nodes 120, various other types of communication networks may be used to support the communications of the nodes 120.

The nodes 120 are configured to support resource virtualization within the virtualization environment 100. The nodes 120 are communicatively connected to the RC 130 such that RC 130 may control the nodes 120.

The nodes 120-1-120-N include sets of physical resources 121-1-121-N, respectively. The physical resources 121-x of a node 120-x may include processing resources (e.g., central processing unit (CPU) resources or other types of processing resources), memory resources (e.g., random access memory (RAM) resources or other types of memory resources), storage resources, input-output resources, networking resources, or the like, as well as various combinations thereof. It will be appreciated that other types of physical resources 121-x may be supported.

The nodes 120-1-120-N include sets of virtual resources 122-1-122-N, respectively, which are provided by the nodes 120-1-120-N using the respective physical resources 121-1-121-N of the nodes 120-1-120-N. The virtual resources 122-x of a node 120-x may include virtual processing resources (e.g., virtual CPU resources of other types of virtual processing resources), virtual memory resources, virtual storage resources, virtual input-output resources, virtual networking resources, or the like, as well as various combinations thereof. The virtual resources 122-x of a node 120-x may be provided in the form of virtual machines (VMs), virtual containers (VCs), or the like, as well as various combinations thereof. It will be appreciated that other types of virtual resources 122-x may be supported.

The nodes 120-1-120-N include local data collection elements 123-1-123-N and local resource schedulers 124-1-124-N, respectively. The local data collection element 123-x and local resource scheduler 124-x of a node 120-x are configured to cooperate to provide various types of local resource management functions, including local resource scheduling functions, locally at the node 120-x. For example, the local resource management functions may include tracking of physical resources 121-x at the node 120-x (e.g., utilized physical resources 121-x, available physical resources 121-x, or the like), tracking of virtual resources 122-x at the node 120-x (e.g., virtual resources 122-x currently running, virtual resources 122-x scheduled to be instantiated at the node 120-x or terminated at the node 120-x, or the like), scheduling of physical resources 121-x at the node 120-x to provide virtual resources 122-x at the node 120-x, allocation of physical resources 121-x at the node 120-x to provide virtual resources 122-x at the node 120-x, deallocation of physical resources 121-x at the node 120-x when virtual resources 122-x are no longer needed at the node 120-x, or the like, as well as various combinations thereof.

The local data collection element 123-x of a node 120-x is configured to provide various data collection functions at the node 120-x for supporting local resource management locally at the node 120-x. The local data collection element 123-x of a node 120-x may be configured to collect local data of the node 120-x. The local data of the node 120-x may include resource utilization/availability data that is indicative of utilization/availability of physical resources 121-x of the node 120-x (e.g., CPU utilization and/or availability, RAM utilization and/or availability, storage utilization and/or availability, or the like). The local data of the node 120-x may be collected in the form of logs on the node 120-x, status messages on the node 120-x, network status information associated with network communications of the node 120-x, or the like. The local data collection element 123-x of a node 120-x may be configured to provide various other data collection functions at the node 120-x for supporting local resource management locally at the node 120-x. The local data collection element 123-x of a node 120-x also may be configured to cooperate with the RC 130 for supporting various other resource control functions within virtualization environment 100.

The local resource scheduler 124-x of a node 120-x is configured to provide various resource scheduling functions at the node 120-x for supporting local resource management locally at the node 120-x. The local resource scheduler 124-x of a node 120-x may be configured to receive the local data (e.g., resource utilization/availability data) of the node 120-x from the local data collection element 123-x of the node 120-x. The local resource scheduler 124-x of a node 120-x may be configured to analyze the local data of the node 120-x. The local resource scheduler 124-x of the node 120-x may be configured to analyze the local data of the node 120-x to determine, for the node 120-x, predicted resource availability information indicative of a prediction of availability of resources of the node 120-x (e.g., a prediction of availability of physical resources 121-x of the node 120-x, a prediction of availability of virtual resources 122-x of the node 120-x, or the like, as well as various combinations thereof). The predicted resource availability information indicative of a prediction of availability of resources of the node 120-x may include predictions of resource availability of resources of the node 120-x at the current time, at a future time, or the like, as well as various combinations thereof. The local resource scheduler 124-x of a node 120-x may be configured to provide various other resource scheduling functions at the node 120-x for supporting local resource management locally at the node 120-x. The local resource scheduler 124-x of a node 120-x, as discussed further below, is configured to cooperate with MRS 140 for supporting various resource management functions within the virtualization environment 100. The local resource scheduler 124-x of a node 120-x also may be configured to cooperate with the RC 130 for supporting various other resource management functions within the virtualization environment 100.

The RC 130 is configured to provide various resource control functions for the nodes 120 of the virtualization environment 100. The RC 130 may be configured to control selection of nodes 120 on which virtual resources 122 are to be provided. The RC 130 may be configured to control allocation of physical resources 121 of the nodes 120 in order to support virtual resources 122 of the nodes 120. The RC 130 may be configured to support instantiation and termination of virtual resources 122 of nodes 120 (e.g., responsive to client requests, based on predetermined schedules, responsive to conditions within the virtualization environment 100, or the like, as well as various combinations thereof). The RC 130 may be configured to provide at least a portion of such resource control functions for the nodes 120 of the virtualization environment 100 based on interaction by the RC 130 with the MRS 140 when the MRS 140 is running at the RC 130 (e.g., based on information available from the MRS 140 when the MRS 140 arrives at the RC 130 after roaming to various nodes 120 of the virtualization environment 100, based on information determined by the MRS 140 when the MRS 140 arrives at the RC 130 after roaming to various nodes 120 of the virtualization environment 100, or the like, as well as various combinations thereof). The RC 130 may be configured to provide at least a portion of such resource control functions for the nodes 120 of the virtualization environment 100 based on network status information received from SDN controller 112 of the SDN-based network. It will be appreciated that the RC 130 may be configured to provide various other types of resource control functions for the nodes 120 of the virtualization environment 100. It will be appreciated that, in at least some embodiments, RC 130 may be considered to be, or may be referred to as, a resource orchestrator for the nodes 120.

The MRS 140 is configured to provide various resource scheduling functions within the virtualization environment 100. The MRS 140, as discussed above, is configured to roam within the virtualization environment 100 by roaming between various elements of the virtualization environment 100 (illustratively, roaming from the RC 130 to nodes 120, roaming between nodes 120, roaming from nodes 120 to the RC 130, and so forth) for supporting scheduling of physical resources 121 of nodes 120 to provide virtual resources 122 at nodes 120. The roaming is illustrated in FIG. 1 using the dotted lines showing the migration of the MRS 140 through virtualization environment 100. The MRS 140 may roam between the elements of the virtualization environment 100 based on use of code mobility (e.g., for the code that is executed to provide MRS 140) and data mobility (e.g., for data collected and produced by MRS 140) by the elements of the virtualization environment. The MRS 140 may determine the visitation order in which the MRS 140 visits elements of virtualization environment 100 in various ways (e.g., the MRS 140 may be provided with a predetermined order in which the elements are to be visited (e.g., by RC 130 or another suitable source of the visitation order), the MRS 140 may predetermine the order in which the elements are to be visited, the MRS 140 may determine the order in which the nodes 120 are to be visited dynamically (e.g., deterministically, randomly, or the like), or the like, as well as various combinations thereof. In the example of FIG. 1, the MRS 140 is configured to roam from the RC 130 to node 120-1, from node 120-1 to node 120-2, and so forth, until finally roaming from node 120-N−1 to node 120-N and then from node 120-N back to the RC 130. It will be appreciated that MRS 140 may roam the RC 130 and the nodes 120 in any other suitable order (e.g., other orders of visiting the nodes 120, visiting one or more nodes 120 multiple times between visits to the RC 130, or the like, as well as various combinations thereof). The MRS 140 is configured to perform various functions while visiting elements of the virtualization environment 100, where the functions that are performed by the MRS 140 may vary for different element types (e.g., RC 130 versus nodes 120), for different types of visitations to the same element type (e.g., starting at the RC 130 versus arriving back at the RC 130 after visiting nodes 120), or the like. The various functions which may be performed by the MRS 140 are discussed further below.

The MRS 140 is configured to run on RC 130. The MRS 140 may begin roaming on RC 130 (e.g., starting on RC 130 before visiting any nodes 120). The MRS 140 may be provided to RC 130, may be instantiated on RC 130, or the like. The MRS 140, before roaming to any nodes 120, may determine a node visitation order in which the nodes 120 are to be visited where the node visitation order may be determined in various ways (e.g., the MRS 140 may be provided with a predetermined order in which the nodes 120 are to be visited (e.g., by the RC 130 or other suitable source), the MRS 140 may predetermine the order in which the nodes 120 are to be visited, the MRS 140 may determine the order in which the nodes 120 are to be visited dynamically (e.g., deterministically, randomly, or the like), or the like, as well as various combinations thereof). The MRS 140, before roaming to any nodes 120, may or may not have resource scheduling control information (e.g., an ordered list of the nodes 120 based on availability of physical resources 121 at the nodes 120 or other type(s) of resource scheduling control information which may be determined by or otherwise available from the MRS 140)) available for use by the RC 130 in performing resource control functions for the virtualization environment 100 (e.g., the MRS 140 may be provided with a predetermined ordered list of the nodes 120, may determine a predetermined ordered list of the nodes 120 (e.g., deterministically not based on previous visits to the nodes 120, deterministically based on previous visits to the nodes 120, randomly, or the like), or the like. The MRS 140 then roams within the virtualization environment 100 (e.g., from the RC 130 to a first one of the nodes 120 (illustratively, node 120-1), between nodes 120, and from a last one of the nodes (illustratively, node 120-N) back to the RC 130) determining resource scheduling control information while roaming within the virtualization environment 100.

The MRS 140 is configured to run on each of the nodes 120. The MRS 140, upon being received by a node 120-x, may be executed by the node 120-x such that the MRS 140 may provide various resource scheduling functions within the virtualization environment 100. The MRS 140 is configured to interface with the local resource scheduler 124-x of the node 120-x. The MRS 140 may be interfaced with the local resource scheduler 124-x of the node 120-x, by the node 120-x, after being received by the node 120-x. The MRS 140 is configured to receive predicted resource availability information of the node 120-x from the local resource scheduler 124-x of the node 120-x (determined, as discussed above, by the local resource scheduler 124-x of the node 120-x based on analysis of resource utilization/availability data received from the local data collection element 123-x of the node 120-x).

The MRS 140 may be configured to simply collect the predicted resource availability information of the node 120-x from the local resource scheduler 124-x of the node 120-x (e.g., for later processing by the MRS 140 at a different roaming location, such as at a different node 120-x or when the MRS 140 returns to the RC 130). The MRS 140 may bring the predicted resource availability information of the node 120-x to the next node 120 to which it roams, and so on, in order to collect predicted resource availability information from each of the nodes 120 (e.g., for later processing by the MRS 140 at the RC 130, for use by the RC 130 to provide resource control functions, or the like, as well as various combinations thereof) as MRS 140 roams through the virtualization environment 100.

The MRS 140 may be configured to determine at the node 120-x, based on the predicted resource availability information of the node 120-x, resource scheduling control information for the virtualization environment 100. The MRS 140 may bring the resource scheduling control information determined at the node 120-x to the next node 120 to which it roams, and so on, in order to dynamically update the resource scheduling control information for the virtualization environment 100 (e.g., for later processing by the MRS 140 at the RC 130, for use by the RC 130 to provide resource control functions, or the like, as well as various combinations thereof) as MRS 140 roams through the virtualization environment 100.

The resource scheduling control information determined by the MRS 140 may be for ones of the nodes 120 visited by the MRS 140 since the MRS 140 last visited the RC 130, for ones of the nodes 120 not yet visited by the MRS 140 since the MRS 140 last visited the RC 130 (e.g., based on initialization information associated with those nodes 120, based on resource scheduling control information determined by the MRS 140 based on one or more previous visits by the MRS 140 to those nodes 120, or the like), or the like, as well as various combinations thereof.

The resource scheduling control information determined by the MRS 140 may include one or more ordered lists of nodes 120. The one or more ordered lists of nodes 120 may include one or more ordered lists of nodes 120 including all of the nodes 120, one or more ordered lists of nodes including only a subset of the node 120 (e.g., nodes 120 visited by the MRS 140 since the MRS 140 last visited the RC 130, nodes 120 having one or more characteristics in common, or the like), one or more ordered lists of nodes based on all physical resource types of the nodes 120, one or more ordered lists of nodes based on a subset of the physical resource types of the nodes 120 (e.g., a CPU only list, a RAM only list, a storage only list, a CPU+RAM list, a CPU+storage list, a RAN+storage list, or the like), or the like, as well as various combinations thereof. The one or more ordered lists of nodes 120 may rank the nodes 120 in various ways (e.g., in an order from greatest to least amount of physical resources 121 available at the nodes 120, in an order from least to greatest amount of physical resources 121 available at the nodes 120, or the like). The one or more ordered lists of nodes 120 may include one or more partial rankings of nodes 120, one or more global rankings of nodes 120, or the like.

The MRS 140, after roaming between the nodes 120 of the virtualization environment 100, returns to the RC 130.

The MRS 140, after returning to the RC 130, may perform various functions based on information obtained by the MRS 140 while roaming through virtualization environment 100 (e.g., predicted resource availability information collected by the MRS 140 from nodes 120, resource scheduling control information for the virtualization environment 100 that is determined by MRS 140 at nodes 120, or the like, as well as various combinations thereof).

The MRS 140, upon returning to the RC 130 with predicted resource availability information collected by the MRS 140 from nodes 120, may process the predicted resource availability information to determine resource scheduling control information for the virtualization environment 100 (e.g., as discussed above with respect to determination of resource scheduling control information determined by MRS 140 at nodes 120).

The MRS 140, upon returning to the RC 130 with resource scheduling control information for the virtualization environment 100 that is determined by the MRS 140 based on processing of predicted resource availability information at the nodes 120, may further process the resource scheduling control information for the virtualization environment 100 (e.g., to update the resource scheduling control information for the virtualization environment 100, to determine new resource scheduling control information for the virtualization environment 100, or the like, as well as various combinations thereof).

The MRS 140, after returning to the RC 130, may obtain network status information associated with the SDN-based network for use in performing various functions. The network status information may be obtained by the MRS 140 from an SDN northbound API via which the SDN controller 112 communicates with RC 130. The network status information may include network status information associated with communications between nodes 120, communications between nodes 120 and elements located outside of the virtualization environment 100, communications between elements of SDN data plane 111, or the like, as well as various combinations thereof. The network status information may include latency information, bandwidth information, or the like, as well as various combinations thereof. The MRS 140 may use a combination of the network status information and predicted resource availability information collected by the MRS 140 from nodes 120 to determine resource scheduling control information for the virtualization environment 100. The MRS 140 may use a combination of the network status information and resource scheduling control information for the virtualization environment 100 that is determined by the MRS 140 based on processing of predicted resource availability information at the nodes 120 to further process the resource scheduling control information for the virtualization environment 100 (e.g., to update the resource scheduling control information for the virtualization environment 100, to determine new resource scheduling control information for the virtualization environment 100, or the like, as well as various combinations thereof).

The resource scheduling control information for the virtualization environment 100 that is determined by the MRS 140 at the RC 130 may include one or more ordered lists of nodes 120. The one or more ordered lists of nodes 120 may include one or more ordered lists of nodes 120 including all of the nodes 120, one or more ordered lists of nodes including only a subset of the node 120 (e.g., nodes 120 having one or more characteristics in common or the like), one or more ordered lists of nodes based on all physical resource types of the nodes 120, one or more ordered lists of nodes based on a subset of the physical resource types of the nodes 120 (e.g., a CPU only list, a RAM only list, a storage only list, a CPU+RAM list, a CPU+storage list, a RAN+storage list, or the like), or the like, as well as various combinations thereof. The one or more ordered lists of nodes 120 may rank the nodes 120 in various ways (e.g., in an order from greatest to least amount of physical resources 121 available at the nodes 120, in an order from least to greatest amount of physical resources 121 available at the nodes 120, or the like). The one or more ordered lists of nodes 120 may include one or more partial rankings of nodes 120, one or more global rankings of nodes 120, or the like.

The MRS 140, as noted above, may roam between elements of virtualization environment 100 (e.g., RC 130 and nodes 120) based on use of code mobility and data mobility. The code of MRS 140, which is executed by an element of the virtualization environment 100 in order to run MRS 140 locally at the element of the virtualization environment 100, may be transferred between the elements of the virtualization environment 100 based on use of code mobility. The data of MRS 140, that is collected or determined by MRS 140 at an element of the virtualization environment 100 based on execution of the MRS 140 locally at the element of the virtualization environment 100, may be transferred between the elements of the virtualization environment 100 based on use of data mobility. It will be appreciated that, for a transfer of MRS 140 between elements of the virtualization environment 100, the code and data may be transferred together or separately. The transfer of the MRS 140 from a first element of the virtualization environment 100 to a second element of the virtualization environment 100 may include: (1) the first element of the virtualization environment 100 stopping the MRS 140 from running at the first element of the virtualization environment 100, packaging the code and data of the MRS 140 at the first element of the virtualization environment 100, and sending the code and data of the MRS 140 to the second element of the virtualization environment 100 and (2) the second element of the virtualization environment 100 receiving the code and data of the MRS 140 from the first element of the virtualization environment 100, storing the code and data of the MRS 140 at the second element of the virtualization environment 100, and configuring the MRS 140 to run at the second element of the virtualization environment 100. It will be appreciated that the transfer of the MRS 140 from a first element of the virtualization environment 100 to a second element of the virtualization environment 100 may include fewer or more, as well as different, actions being performed by the first element of the virtualization environment 100 and/or the second element of the virtualization environment 100.

The MRS 140 may be configured to provide various other functions while roaming within the virtualization environment 100. The MRS 140 may be configured to blacklist nodes 120 based on various conditions (e.g., resource availability of a node 120-x being below a threshold, resource utilization of a node 120-x being above a threshold, detection of a hardware or software problem on the node 120-x, or the like, as well as various combinations thereof). The MRS 140 may be configured to whitelist nodes 120 based on various conditions (e.g., resource availability of a node 120-x being above a threshold, resource utilization of a node 120-x being below a threshold, detection of resolution of a hardware or software problem on the node 120-x, or the like, as well as various combinations thereof). The MRS 140 may be configured to provide various other functions while roaming within the virtualization environment 100.

The RC 130, as discussed above, is configured to provide various resource control functions for the nodes 120 of the virtualization environment 100 based on interaction by the RC 130 with the MRS 140 when the MRS 140 is running at the RC 130 (e.g., based on information available from the MRS 140 when the MRS 140 arrives at the RC 130 after roaming to various nodes 120 of the virtualization environment 100, based on information determined by the MRS 140 when the MRS 140 arrives at the RC 130 after roaming to various nodes 120 of the virtualization environment 100, or the like, as well as various combinations thereof). The RC 130 may be configured to control selection of nodes 120 on which virtual resources 122 are to be provided based on resource scheduling control information for the virtualization environment 100 (e.g., selecting a first node 120 in an ordered list of nodes 120 where the ordered list of nodes 120 ranks the nodes in an order of decreasing availability of physical resources 121). The RC 130 may be configured to control allocation of physical resources 121 of the nodes 120 in order to support virtual resources 122 of the nodes 120. The RC 130 may be configured to support instantiation and termination of virtual resources 122 of nodes 120. The RC 130 may be configured to track resource utilization on each node 120, based on the resource scheduling control information for the virtualization environment 100 that is determined by the MRS 140, to ensure that workload is not scheduled to be more than the available resources (e.g., based on comparisons of resource availability and existing workloads assigned to nodes 120). It is noted that the functions performed by the MRS 140 enable the RC 130 to use node resources efficiently, to work with user-supplied placement constraints, to support scheduling of applications rapidly to prevent them from entering or remaining in a pending state, to support a degree of “fairness” in resource allocation, to be robust to errors and always available, or the like, as well as various combinations thereof. The RC 130 may be configured to provide various other resource control functions for the nodes 120 of the virtualization environment 100 based on interaction by the RC 130 with the MRS 140 when the MRS 140 is running at the RC 130.

It will be appreciated that, although primarily presented herein with respect to embodiments in which the MRS 140 visits the nodes 120 in the same order each time the MRS 140 roams, the order in which the MRS 140 visits the nodes 120 may change based on various conditions, such as periodically (e.g., after every x-th time roaming to the nodes, once each hour, or the like), responsive to detection of a condition by the MRS 140 or the RC 130 (e.g., a condition on a node 120, a problem with a node 120, a failure of a node 120, or the like), or the like, as well as various combinations thereof.

It will be appreciated that, although omitted from FIG. 1 for purposes of clarity, the resource scheduling control information that is determined by the MRS 140 may be shared (e.g., by MRS 140 or RC 130) with one or more other elements (e.g., one or more other elements of virtualization environment 100, one or more elements outside of virtualization environment 100, or the like, as well as various combinations thereof. The one or more other elements may include one or more other elements providing resource control functions for one or more other sets of nodes of virtualization environment 100 (e.g., for other clusters of nodes of virtualization environment 100), one or more other elements providing resource control functions for one or more other sets of nodes of one or more other virtualization environments which may or may not be associated with virtualization environment 100 (e.g., for other clusters of nodes of one or more other virtualization environments), or the like, as well as various combinations thereof. The one or more other elements may include resource controllers, network management systems, or the like, as well as various combinations thereof. The one or more other elements may include one or more authorized clusters and the RC 130 may be configured to negotiate resources with the one or more authorized clusters depending on various key performance indicators (KPIs). The one or more elements may include various other types of elements.

It will be appreciated that, although omitted from FIG. 1 for purposes of clarity, the nodes 120 may be part of a single cluster of nodes, may be distributed across multiple clusters of nodes, or the like. It will thus be appreciated that the MRS 140 may be configured to roam between nodes 120 of a single cluster, roam between nodes 120 of multiple clusters (without or without roaming back to the MRS 140 between clusters), or the like, as well as various combinations thereof. It also will be appreciated that the various function which may be supported by the MRS 140 (as well as by RC 130) may thus be provided on a per-cluster basis (e.g., per-cluster node rankings), for one or more sets of clusters (e.g., a node ranking for nodes of multiple clusters), or the like.

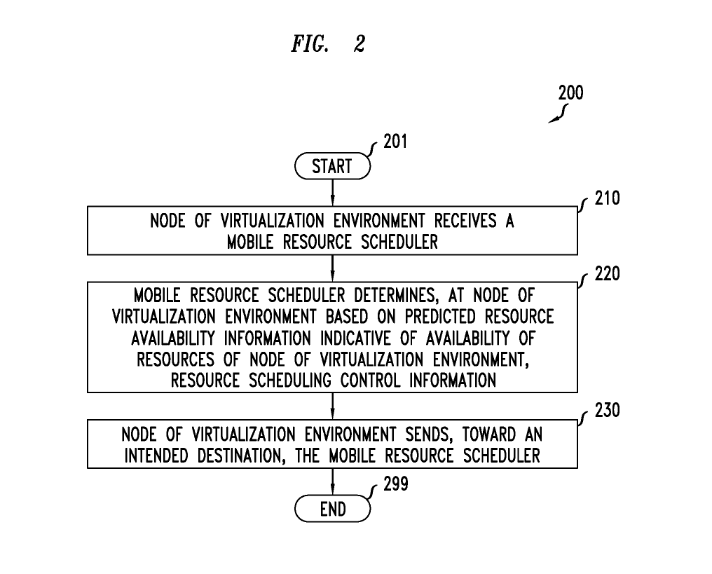

FIG. 2 depicts an embodiment of a method for use by a node of a virtualization environment to support use of a mobile resource scheduler for supporting resource scheduling functions within the virtualization environment. The node of the virtualization environment includes a set of physical resources configured to support a set of virtual resources. It will be appreciated that, although primarily presented herein as being performed serially, at least a portion of the functions of method 200 may be performed contemporaneously or in a different order than as presented in FIG. 2. At block 201, method 200 begins. At block 210, the node of the virtualization environment receives a mobile resource scheduler. The mobile resource scheduler may be received from a second node of the virtualization environment or from a resource controller of the virtualization environment. At block 220, the mobile resource scheduler determines, at the node based on predicted resource availability information indicative of availability of the resources of the node, resource scheduling control information. At block 230, the node sends, toward an intended destination, the mobile resource scheduler. The intended destination of the mobile resource scheduler may be a second node of the virtualization environment or a resource controller of the virtualization environment. At block 299, method 200 ends.

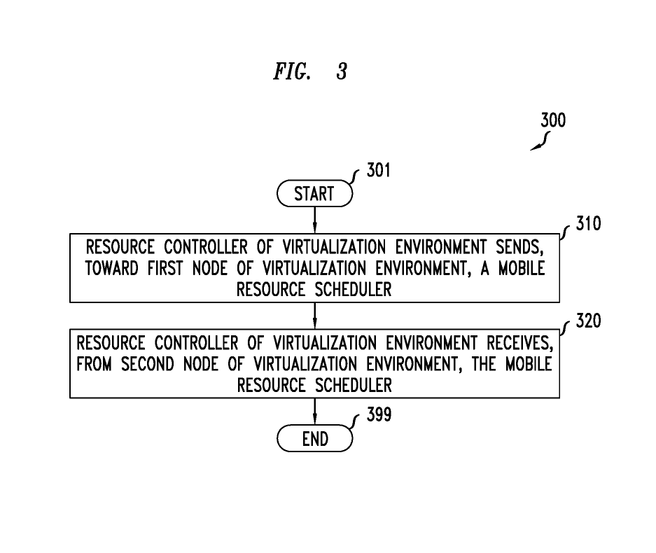

FIG. 3 depicts an embodiment of a method for use by a resource controller of a virtualization environment to support use of a mobile resource scheduler for supporting resource scheduling functions within the virtualization environment. The mobile resource scheduler is configured to determine, based on predicted resource availability information of one or more nodes of the virtualization environment, resource scheduling control information. It will be appreciated that, although primarily presented herein as being performed serially, at least a portion of the functions of method 300 may be performed contemporaneously or in a different order than as presented in FIG. 3. At block 301, method 300 begins. At block 310, the resource controller of the virtualization environment sends, toward a first node of the virtualization environment, the mobile resource scheduler. At block 320, the resource controller of the virtualization environment receives, from a second node of the virtualization environment, the mobile resource scheduler. At block 399, method 300 ends.

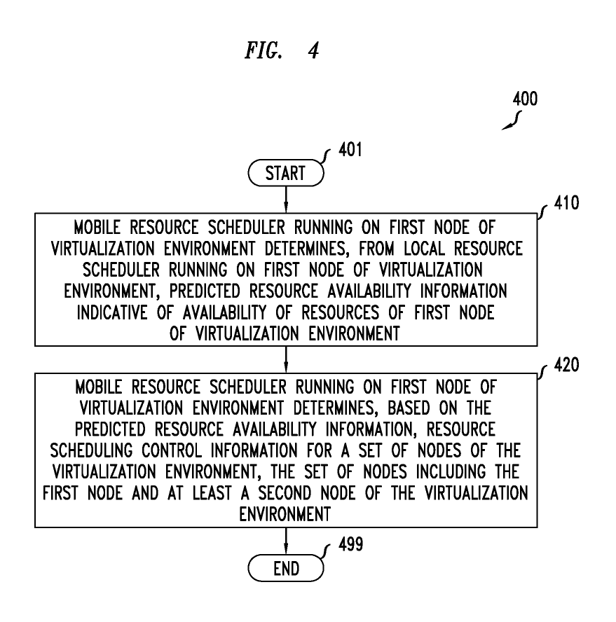

FIG. 4 depicts an embodiment of a method for use by a mobile resource scheduler for supporting resource control functions within the virtualization environment. It will be appreciated that, although primarily presented herein as being performed serially, at least a portion of the functions of method 400 may be performed contemporaneously or in a different order than as presented in FIG. 4. At block 401, method 400 begins. At block 410, the mobile resource scheduler running on a first node of a virtualization environment determines, from a local resource scheduler running on the first node, predicted resource availability information indicative of availability of resources of the first node. At block 420, the mobile resource scheduler running on the first node of the virtualization environment determines, based on the predicted resource availability information, resource scheduling control information for a set of nodes of the virtualization environment, the set of nodes including the first node and at least a second node of the virtualization environment. At block 499, method 400 ends.

It will be appreciated that, although primarily presented herein within respect to embodiments in which a node is a physical node including physical resources that may be allocated to support virtual resources, in at least some embodiments a node may be a virtual node (e.g., a VM, a VC, or other suitable type of virtual node). In at least some such embodiments, the mobile resource scheduler, when running on such a virtual node, may determine, from a local resource scheduler running on the first node, predicted resource availability information indicative of availability of virtual resources of the virtual node and, further, may determine, based on the predicted resource availability information, resource scheduling control information for a set of virtual nodes of the virtualization environment (e.g., where the set of nodes of the virtualization environment may include the virtual node and one or more other virtual nodes).

Various embodiments of the resource scheduling capability may provide various advantages or potential advantages. In at least some embodiments, for example, the resource scheduling capability utilizes a roaming mobile resource scheduler which roams the nodes of the virtualization environment to collect results from the nodes locally and dynamically ranks the nodes of the virtualization environment based on the collected results, rather than a central resource scheduler that collects results from the nodes remotely and creates a more static ranking of the nodes of the virtualization environment, thereby enabling the image of available resources of the virtualization environment to be closer to reality. In at least some embodiments, for example, use of the resource scheduling capability in a virtualization environment results in a better image of available resources of the virtualization environment (e.g., closer to the actual state of the virtualization environment) than the image of available resources of the virtualization environment that is typically provided by a resource orchestrator in a virtualization environment when the resource scheduling capability is not used (e.g., farther from the actual state of the virtualization environment). In at least some embodiments, for example, use of the resource scheduling capability in a virtualization environment results in a better image of available resources of the virtualization environment than the image of available resources of the virtualization environment that is typically provided by a resource orchestrator in a virtualization environment when the resource scheduling capability is not used (e.g., the resource scheduling capability may reduce or even eliminate delay that is typically introduced by the orchestrator architecture and resource scheduling algorithms in a virtualization environment that is not using the resource scheduling capability, thereby resulting in a more timely image of the available resources of the virtualization environment and potentially a near-real-time or real-time image of the available resources of the virtualization environment). In at least some embodiments, for example, use of the resource scheduling capability in a virtualization environment results in a real-time or near-real-time image of available resources of the virtualization environment, which may be particularly well-suited for use in supporting resource virtualization for real-time applications, such as network function virtualization (e.g., 5G mobile cellular networks or the like), in which delays introduced by the orchestrator architecture and the resource scheduling algorithms in a virtualization environment that is not using the resource scheduling capability may be unacceptable. In at least some embodiments, for example, the resource scheduling capability may be applied within certain network contexts (e.g., 5G networks, IoT slicing, or the like) in order to enable the associated orchestrator to react quickly to answer to KPIs (e.g., latency, bandwidth, or the like, as well as various combinations thereof) and to reconfigure the network and improve or optimize placement of VNFs. Various embodiments of the resource scheduling capability may provide various other advantages or potential advantages.

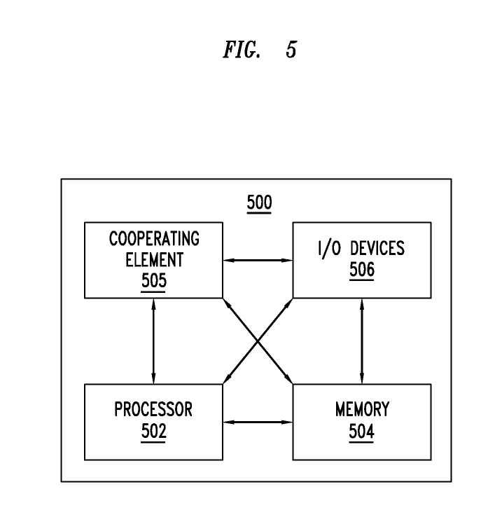

FIG. 5 depicts a high-level block diagram of a computer suitable for use in performing various functions described herein.

The computer 500 includes a processor 502 (e.g., a central processing unit (CPU), a processor having a set of one or more processor cores, or the like) and a memory 504 (e.g., a random access memory (RAM), a read only memory (ROM), or the like). The processor 502 and the memory 504 are communicatively connected.

The computer 500 also may include a cooperating element 505. The cooperating element 505 may be a hardware device. The cooperating element 505 may be a process that can be loaded into the memory 504 and executed by the processor 502 to implement functions as discussed herein (in which case, for example, the cooperating element 505 (including associated data structures) can be stored on a non-transitory computer-readable storage medium, such as a storage device or other storage element (e.g., a magnetic drive, an optical drive, or the like)).

The computer 500 also may include one or more input/output devices 506. The input/output devices 506 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices or elements (e.g., a tape drive, a floppy drive, a hard disk drive, a compact disk drive, or the like), or the like, as well as various combinations thereof.

It will be appreciated that computer 500 of FIG. 5 may represent a general architecture and functionality suitable for implementing functional elements described herein, portions of functional elements described herein, or the like, as well as various combinations thereof. For example, computer 500 may provide a general architecture and functionality that is suitable for implementing one or more of an element of SDN data plane 111 or a portion thereof, SDN controller 112 or a portion thereof, a node 120 or a portion thereof, RC 130 or a portion thereof, MRS 140 or a portion thereof, or the like, as well as various combinations thereof.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive, by a node of a virtualization environment, a mobile resource scheduler, the node comprising a set of physical resources configured to support a set of virtual resources;
determine, by the mobile resource scheduler based on predicted resource availability information indicative of availability of resources of the node, resource scheduling control information; and
send, by the node toward an intended destination, the mobile resource scheduler.

2. The apparatus of claim 1, wherein the mobile resource scheduler is received from a resource controller of the virtualization environment or a second node of the virtualization environment.

3. The apparatus of claim 1, wherein the mobile resource scheduler, when received by the node, includes initial resource scheduling control information.

4. The apparatus of claim 3, wherein the resource scheduling control information is determined based on the initial resource scheduling control information.

5. The apparatus of claim 3, wherein the initial resource scheduling control information comprises an ordered list of a set of nodes of the virtualization environment.

6. The apparatus of claim 1, wherein the processor is configured to:
receive, by a local resource scheduler of the node from a local data collection agent of the node, local resource utilization/availability data collected by the local data collection agent at the node; and
determine, by the local resource scheduler based on the local resource utilization/availability data, the predicted resource availability information indicative of availability of the resources of the node.

7. The apparatus of claim 6, wherein the local resource utilization/availability data comprises at least one of data from a log of the node or data from a status message of the node.

8. The apparatus of claim 1, wherein the predicted resource availability information indicative of availability of the resources of the node comprises at least one of information indicative of availability of physical resources of the node or information indicative of availability of virtual resources of the node.

9. The apparatus of claim 1, wherein the mobile resource scheduler is sent toward a second node of the resource virtualization environment or a resource controller of the virtualization environment.

10. The apparatus of claim 1, wherein the mobile resource scheduler, when sent by the node, includes the resource scheduling control information.

11. An apparatus, comprising:
a processor and a memory communicatively connected to the processor, the processor configured to:
send, by a resource controller of a virtualization environment toward a first node of the virtualization environment, a mobile resource scheduler; and
receive, by the resource controller from a second node of the virtualization environment, the mobile resource scheduler;
wherein the mobile resource scheduler is configured to determine, based on predicted resource availability information of one or more nodes of the virtualization environment, resource scheduling control information.

12. The apparatus of claim 11, wherein the mobile resource scheduler, when sent by the resource controller, includes initial resource scheduling control information.

13. The apparatus of claim 12, wherein the initial resource scheduling control information comprises an ordered list of a set of nodes of the virtualization environment.

14. The apparatus of claim 11, wherein the mobile resource scheduler, when received by the resource controller, includes the resource scheduling control information.

15. The apparatus of claim 14, wherein the resource scheduling control information comprises an ordered list of a set of nodes of the virtualization environment.

16. The apparatus of claim 11, wherein the mobile resource scheduler, when received by the resource controller, includes predicted resource availability information associated with the first node and predicted resource availability information associated with the second node.

17. The apparatus of claim 16, wherein the mobile resource scheduler, when received by the resource controller, includes predicted resource availability information associated with a third node of the virtualization environment.

18. The apparatus of claim 11, wherein the processor is configured to:
receive, from a network controller configured to control a communication network supporting communications of the virtualization environment, network status information.

19. The apparatus of claim 18, wherein the mobile resource scheduler is configured to determine the resource scheduling control information based on the network status information.

20. The apparatus of claim 11, wherein the processor is configured to:
mark, by the resource controller based on the resource scheduling control information, one of the nodes of the virtualization environment as being blacklisted from allocation of physical resources or whitelisted for allocation of physical resources.

21. An apparatus, comprising:
a processor and a memory communicatively connected to the processor, the processor configured to:
determine, by a mobile resource scheduler running on a first node of a virtualization environment from a local resource scheduler running on the first node, predicted resource availability information indicative of availability of physical resources of the first node; and
determine, by the mobile resource scheduler running on the first node based on the predicted resource availability information, resource scheduling control information for a set of nodes of the virtualization environment, the set of nodes including the first node and at least a second node of the virtualization environment.
